(19) United States
(12) Patent Application Publication
(10) Pub. No.: US 2026/0288718 A1
(43) Pub. Date: Sep. 24, 2026

(54) TRANSLATING STRUCTURED QUERY LANGUAGE (SQL) INTO COMMON TABLE EXPRESSION (CTE)

(71) Applicant: INTERNATIONAL BUSINESS MACHINES CORPORATION, Armonk, NY (US)

(72) Inventors: LUIS DANIEL POLANCO CARBAJAL, Ecatepec de Morelos (MX); JORGE DOMINIC MARQUEZ MUÑOZ, Guadalajara (MX); JONAS JAIME, Zapopan (MX); GUSTAVO PRECIADO FLORES, El Salto (MX); NAMIT KABRA, Hyderabad (IN)

(21) Appl. No.: 19/085,569

(22) Filed: Mar. 20, 2025

(51) Int. Cl. G06F 16/2453

(52) U.S. Cl. CPC G06F 16/2453

(57) ABSTRACT

Embodiments receive a SQL query; determine a first execution time of the SQL query; create a linear regression graph with a fitted linear regression line by utilizing a linear regression model; determine that there is a new query with a clause; determine a second execution time of the new query; create a CTE based version of the new query; create a result set of the CTE based version on the new query; predict a third execution time of the CTE based version of the new query; and replace the SQL query with the CTE based version of the new query in response to the predicted third execution time of the CTE based version of the new query being less than the first execution time of the SQL query.

### BACKGROUND

Aspects of the present invention relate generally to a system and a method for translating structured query language (SQL) into a common table expression (CTE) based on qualifiers.

SQL is a type of language that allows data manipulation in a database, which can perform advanced calculations and algebra. Further, the CTE is a one-time result set only for a duration of a query.

### SUMMARY

In a first aspect of the invention, there is a method including: receiving a structured query language (SQL) query from a user repository; determining a first execution time of the SQL query; creating a linear regression graph with a fitted linear regression line by utilizing a linear regression model based on the first execution time and a result set of rows of the SQL query; determining that there is a new query with a clause; determining a second execution time of the new query; creating a common table expression (CTE) based version of the new query based on the second execution time of the new query; creating a result set of the CTE based version of the new query; predicting a third execution time of the CTE based version of the new query; and replacing the SQL query with the CTE based version of the new query in response to the predicted third execution time of the CTE based version of the new query being less than the first execution time of the SQL query.

In another aspect of the invention, there is a computer program product including one or more computer readable storage media and program instructions stored on the one or more computer readable storage media to perform operations including: receiving a structured query language (SQL) query from a user repository; determining a first execution time of the SQL query; creating a linear regression graph with a fitted linear regression line by utilizing a linear regression model based on the first execution time and a result set of rows of the SQL query; determining that there is a new query with a clause; determining a second execution time of the new query; creating a common table expression (CTE) based version of the new query based on the second execution time of the new query; creating a result set of the CTE based version of the new query; predicting a third execution time of the CTE based version of the new query; and replacing the SQL query with the CTE based version of the new query in response to the predicted third execution time of the CTE based version of the new query being less than the first execution time of the SQL query.

In another aspect of the invention, there is a system including a processor set, one or more computer readable storage media, and program instructions stored on the one or more computer readable storage media to cause the processor set to perform operations including: receiving a structured query language (SQL) query from a user repository; determining a first execution time of the SQL query; creating a linear regression graph with a fitted linear regression line by utilizing a linear regression model based on the first execution time and a result set of rows of the SQL query; determining that there is a new query with a clause being typed; determining a second execution time of the new query; creating a common table expression (CTE) based version of the new query based on the second execution time of the new query; creating a result set of the CTE based version of the new query; predicting a third execution time of the CTE based version of the new query; suggesting a replacement of the SQL query with the CTE based version of the new query; and replacing the SQL query with the CTE based version of the new query in response to an acceptance of a suggestion that the SQL query be replaced with the CTE based version of the new query.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows exemplary interfaces of a user input query and a CTE output query in accordance with aspects of the present invention.

FIG. 4 shows a flowchart of an exemplary method in accordance with aspects of the present invention.

FIG. 5 shows a flowchart of an exemplary method in accordance with aspects of the present invention.

FIG. 6 shows a flowchart of an exemplary method in accordance with aspects of the present invention.

FIG. 7 shows a flowchart of an exemplary method in accordance with aspects of the present invention.

FIG. 8 shows exemplary interfaces of a user input query and a CTE output query in accordance with aspects of the present invention.

FIG. 9 shows exemplary interfaces of a user input query and a CTE output query in accordance with aspects of the present invention.

FIG. 10 shows exemplary interfaces of a user input query and a CTE output query in accordance with aspects of the present invention.

FIG. 11 shows exemplary interfaces of a user input query and a CTE output query in accordance with aspects of the present invention.

FIG. 12 shows exemplary interfaces of a user input query and a CTE output query in accordance with aspects of the present invention.

FIG. 13 shows a first graph and a second graph of an exemplary use case in accordance with aspects of the present invention.

FIG. 14 shows a flowchart of the exemplary use case in accordance with aspects of the present invention.

FIG. 15 shows a third graph of the exemplary use case in accordance with aspects of the present invention.

### DETAILED DESCRIPTION

Aspects of the present invention relate generally to a system and a method for translating SQL into a CTE based on qualifiers. In embodiments of the present invention, the system generates the CTE to improve query performance on the SQL query. In further embodiments of the present invention, the CTE also improves readability and facilitates quicker maintenance in comparison to the SQL query.

In particular, aspects of the present invention provide a system, a computer program product, and a computer-implemented method to convert SQL queries into a more readable format and generating the CTE to improve the query performance and facilitate maintenance of the code. In further aspects of the present invention, the system, the computer program product, and the computer-implemented method utilizes a computational automated algorithm which is based on performance predictions using a linear regression machine learning model.

Embodiments of the present invention provide a computer-implemented method, a system, and a computer program product for refactoring a context of a query based on tables and respective columns and column transformations. In particular, the tables and respective column and column transformations are each moved into separated CTEs and are identified by a mandatory table alias per each table and a mandatory column identifier qualifier per each column. Aspects of the present invention generate a final CTE to perform clause functions in a single step for all of the CTE in order to produce a same result based on a granularity defined in an original SQL query. For example, the clause functions comprise JOIN clauses and AGGREGATION clauses. Embodiments of the present invention also provide an automated method which automatically improves code readability. Aspects of the present invention provide a real-time recommendation on an optimal query. Implementations of the present invention also provide an option to rewrite a current query based on a recommendation of an optimal query.

Embodiments of the present invention improve a quality and consistency of information in an SQL query. Aspects of the present invention provide better execution of calculations and decreased time spent on data management. Further embodiments of the present invention provide data integrity using a disciplined approach to data management. Further, aspects of the present invention provide code simplification to enable more efficient queries and better query results.

Aspects of the present invention include a method, system, and computer program product for providing an SQL code converter for improved legibility and performance based on rewriting an input query into common table expressions using a real-time recommendation system based on a machine learning regression model that fits current saved queries and performance times. For example, a computer-implemented method includes: identifying SQL queries and views saved in a user's repository; determining a total count of records that result from each JOIN clause in the SQL query and sum a total count into a result set, the result set is measured in a number of rows; determining an execution time of the queries, the execution time is measured in seconds; normalizing a result set of rows using a mean and standard deviation of the result set; generating and fitting a linear regression model using a normalized result set as an X-axis and execution time as an Y-axis in the queries; determining if there is a new query with a JOIN clause input typed; retrieving, based on a determination of a new JOIN clause, the execution time of the JOIN clauses, and keeping this execution time for further reference; generating a new version of the query based on CTEs; calculating the new result set of this new version of the query; normalizing the new result set; predicting, based on the new result set, the new execution time the CTE version of the query will take, using the linear regression model; determining there is an improvement of the new execution time; suggesting that the query is replaced with the new query; and replacing, based on receiving a positive response, the query with the new query, and re-fitting the model to consider the new query, using the result set and actual time from the new query.

Embodiments of the present invention provide an SQL code converter for improved legibility and performance based on rewriting an input query into common table expressions (CTEs). In contrast, conventional systems include SQL queries which do not align with SQL coding practices, making it hard to understand and work with, which leads to stress and time loss. Accordingly, conventional systems include badly written queries which lead to serious performance issues. Further, conventional systems have difficulty with maintaining codes and include queries which slow the processes and execution.

Embodiments of the present invention include a system, method, and computer program product for eliminating redundancy in SQL queries by utilizing the CTEs. Accordingly, implementations of the present invention improve the readability of the code by breaking a query into several steps that are ordered sequentially to product similar results with better performance. In particular, embodiments of the present invention provide an automated method, more optimal queries of higher performance, and improvements in the SQL query language. Further, embodiments of the present invention provide better execution of calculations and database management, improved data integrity, and better coding practices with better query results.

Implementations of the present invention are necessarily rooted in computer technology. For example, the steps of creating a linear regression graph with a fitted linear regression line by utilizing a linear regression model based on the first execution time and a result set of rows of the SQL query, creating a CTE based version of a new query with a JOIN clause based on a second execution time of the new query with the JOIN clause, and replacing the SQL query with the CTE based version of the new query in response to a predicted third execution time of the CTE based version of the new query being less than the first execution time of the SQL query cannot be performed in the human mind (or with pen and paper). In embodiments, creating a linear regression graph by utilizing a linear regression model, creating a CTE based version of a new query with a JOIN clause, and replacing the SQL query with the CTE based version of the new query is, by definition, performed by a computer and cannot be performed in the human mind (or with a pen and paper). In further embodiments, the steps of the linear regression model including a machine learning linear regression model that is trained on historical SQL queries using a linear regression algorithm is also rooted in computer technology and cannot be performed in the human mind (or with pen and paper).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as an SQL converter code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

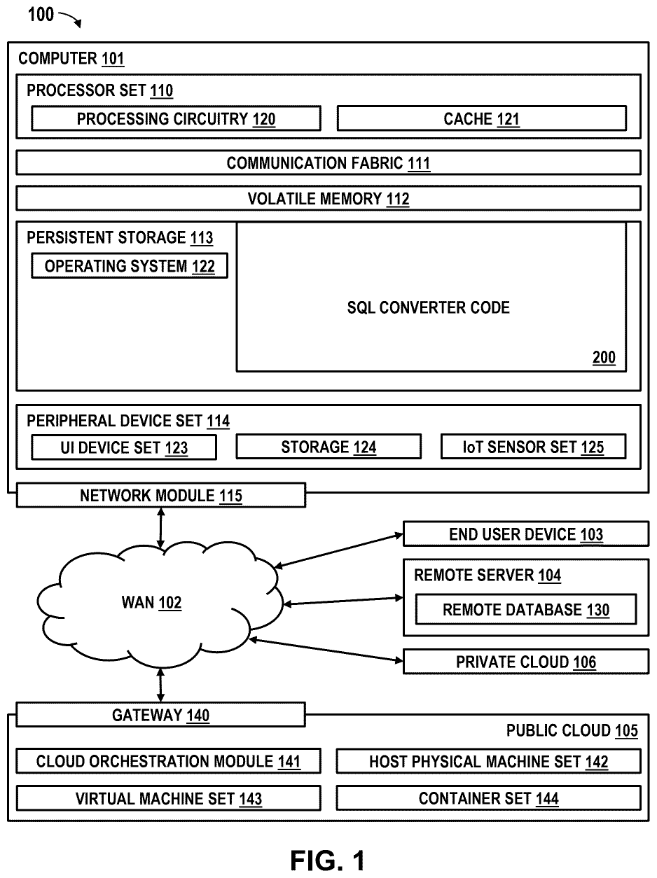

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and rewriting of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

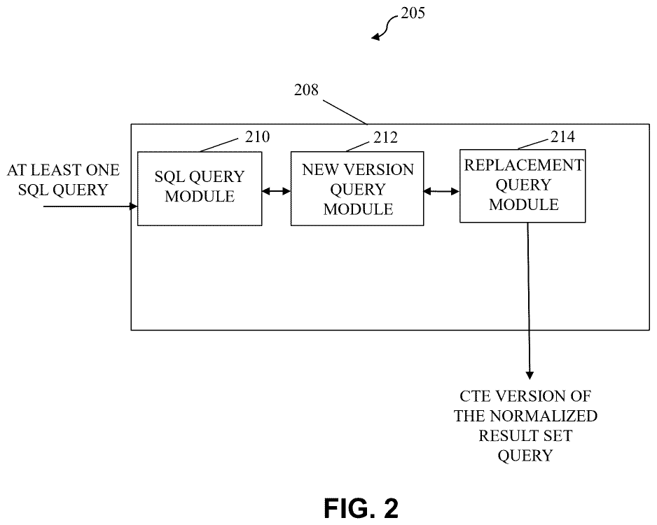

FIG. 2 shows a block diagram of an exemplary environment 205 in accordance with aspects of the present invention. In embodiments, the environment 205 includes an SQL converter server 208, which may comprise one or more instances of the computer 101 of FIG. 1. In other examples, the SQL converter server 208 comprises one or more virtual machines or one or more containers running on one or more instances of the computer 101 of FIG. 1.

In embodiments, the SQL converter server 208 of FIG. 2 comprises an SQL query module 210, a new version query module 212, and a replacement query module 214, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the present invention as described herein. These modules of the code of block 200 are executable by the processing circuitry 120 of FIG. 1 to perform the inventive methods as described herein. The SQL converter server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In embodiments, the SQL query module 210 receives at least one SQL query and views from a user repository. In further embodiments, the user repository comprises a git repository. In embodiments of the present invention, git comprises a free and open source distributed version control system. In aspects of the present invention, the user repository comprises a local storage.

In aspects of the present invention, the SQL query module 210 determines a total count of records that result from each JOIN clause in the at least one SQL query. In further embodiments, the SQL query module 210 sums the total count of records that result from each JOIN clause as a result set. In embodiments of the present invention, the result set is measured in a number of rows. In aspects of the present invention, the SQL query module 210 determines an execution time of each of the at least one SQL query. In further embodiments, the execution time is measured in seconds.

In embodiments of the present invention, the SQL query module 210 also normalizes the result set of rows for legibility and easier manipulation of numbers based on the mean and standard deviation of the result set of the at least one SQL query. In further embodiments of the present invention, the SQL query module 210 utilizes a linear regression model which creates a linear regression graph with the normalized result set on the X-axis as an independent variable and execution time on the Y-axis as a dependent variable of the at least one SQL query. In particular, the SQL query module 210 utilizes the linear regression model to fit a linear regression line on the linear regression graph by utilizing the normalized result set and the execution time. In further embodiments, the linear regression model comprises a machine learning linear regression model. In aspects of the present invention, the machine learning linear regression model is trained on historical SQL queries using a linear regression algorithm.

In aspects of the present invention, the SQL query module 210 checks to see if there is a new query with a JOIN clause being typed by a user on a user computing device. In embodiments, the SQL query module 210 determines an execution time of the JOIN clause of the new query in response to determining that there is a new query with a JOIN clause being typed. In further embodiments, the SQL query module 210 saves the execution time in memory for future reference. In aspects of the present invention, the SQL query module 210 stays idle until there is a new query with a JOIN clause being typed in response to determining that the is no new query with the JOIN clause being typed. The SQL query module 210 sends the new query with the JOIN clause being typed and the corresponding execution time to the new version query module 212.

In embodiments, the new version query module 212 receives the new query with the JOIN clause being typed and the corresponding execution time. In further embodiments, the new version query module 212 identifies table aliases and column identifier qualifiers from the new query with the JOIN clause being typed, while maintaining a same order of appearance. For example, the table aliases may correspond with <table_name>. In embodiments, the new version query module 212 further identifies and maps each column with the table of the new query with the JOIN clause being typed by matching the column identifier with the table aliases. In further embodiments, the new version query module 212 checks whether an aggregation function is performed. In aspects of the present invention, the new version query module 212 keeps the GROUP by columns, while maintaining the order of appearance in response to determining that the aggregation function is performed. In embodiments, the GROUP by columns comprises an SQL clause that groups all of the rows with a same column value. For example, the corresponding function is <group_by_columns>. Then, in embodiments of the present invention, the new version query module 212 packs each aggregate function with its column after keeping the GROUP by columns. In further embodiments, the new version query module 212 packs each column with its identifier with and without functions, as well as the WHERE clauses (except for aggregates if any). For example, the corresponding functions are <columns_mapped_from_identifier>, <original_columns>, <where_clauses>. In aspects of the present invention, the new version query module 212 identifies JOIN clauses and criteria, while maintaining a same order of appearance. For example, the corresponding function is <join_criteria>. In embodiments, the new version query module 212 creates a common table expression (CTE) for each table in its order of appearance. For example, the new version query module 212 creates the CTE for each table as follows:

WITH CTE_<table_name> AS (
SELECT <columns_mapped_from_identifier>
FROM <table_name>
WHERE 1 = 1
AND <where_clauses>
).

In aspects of the present invention, the new version query module 212 maps each new CTE with its original table and replaces the JOIN clauses. For example, the corresponding function is <join_criteria_with_cte>. In embodiments, the new version query module 212 checks if there are stored aggregate functions. In aspects of the present invention, the new version query module 212 creates a final CTE without aggregates in response to determining that there are no stored aggregate functions. For example, the final CTE without aggregates is as follows:

```
WITH cte_ResultSet AS (
    SELECT <original_columns>
    FROM <join_criteria_with_cte>
    WHERE 1 = 1
).
```

In embodiments, the new version query module 212 creates a final CTE with aggregates in response to determining that there are stored aggregate functions. For example, the final CTE with aggregates is as follows:

```
WITH cte_ResultSet AS (
    SELECT <original_columns>, <aggregate_columns>
    FROM <join_criteria_with_cte>
    WHERE 1 = 1
    GROUP BY <group_by_columns>
).
```

In further embodiments of the present invention, the new version query module 212 creates a result set from the final CTE. For example, the result set is as follows:
SELECT rs.*(enumerated)
FROM cte_ResultSet rs
WHERE 1=1.

In aspects of the present invention, the new version query module 212 sends the result set to the replacement query module 214. In embodiments, the replacement query module 214 normalizes the result set based on the mean and standard deviation of the result set, predicts an execution time of the CTE version of the normalized result set based on the linear regression model with the linear regression graph, checks if there is an improvement in the execution time of the CTE version of the normalized result set over the previously saved execution time in memory, discards the CTE version of the normalized result set in response to determining that there is no improvement in the execution time of the CTE version of the normalized result set over the previously saved execution time in memory, and suggests the CTE version of the normalized result set to the user to replace the current query (i.e., the at least one SQL query) in response to determining that there is improvement in the execution time of the CTE version of the normalized result set over the previously saved execution time in memory.

In embodiments, the replacement query module 214 also replaces the current query (i.e., the at least one SQL query) with the CTE version of the normalized result set in response to the user accepting the suggestion of the CTE version of the normalized result set, re-fits the linear regression model with the linear regression graph to consider the CTE version of the normalized result set using the result set of the normalized result set and corresponding actual time, outputs the CTE version of the normalized result set, and discards the CTE version of the normalized result set in response to the user not accepting the suggestion of the CTE version of the normalized result set. In this scenario, the replacement module 214 stays idle.

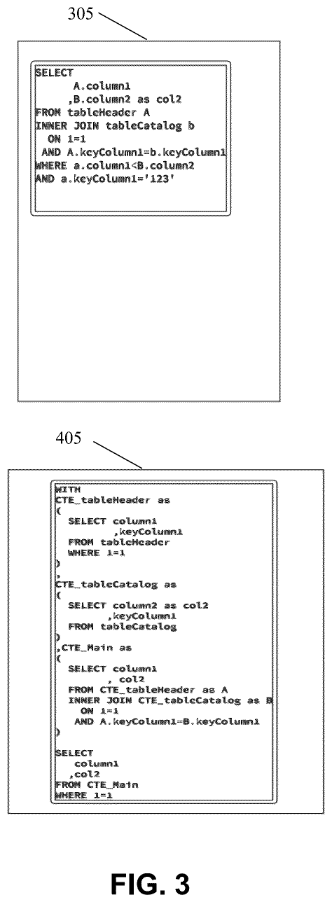

FIG. 3 shows exemplary interfaces of a user input query in accordance with aspects of the present invention. In FIG. 3, the user input query 305 includes a SELECT function (for columns), a FROM function (from a table), an INNER JOIN function, a WHERE function, and an AND function. FIG. 3 also shows an exemplary interface of a CTE output query 405 in accordance with aspects of the present invention. In FIG. 3, the SQL converter server 208 creates the CTE output query 405 based on the user input query 305. For example, the SQL converter server 208 receives the user input query 305 and creates the CTE output query 405 based on the user input query 305. In further embodiments, the CTE output query 405 includes a CTE query which corresponds with a CTE version of the user input query 305.

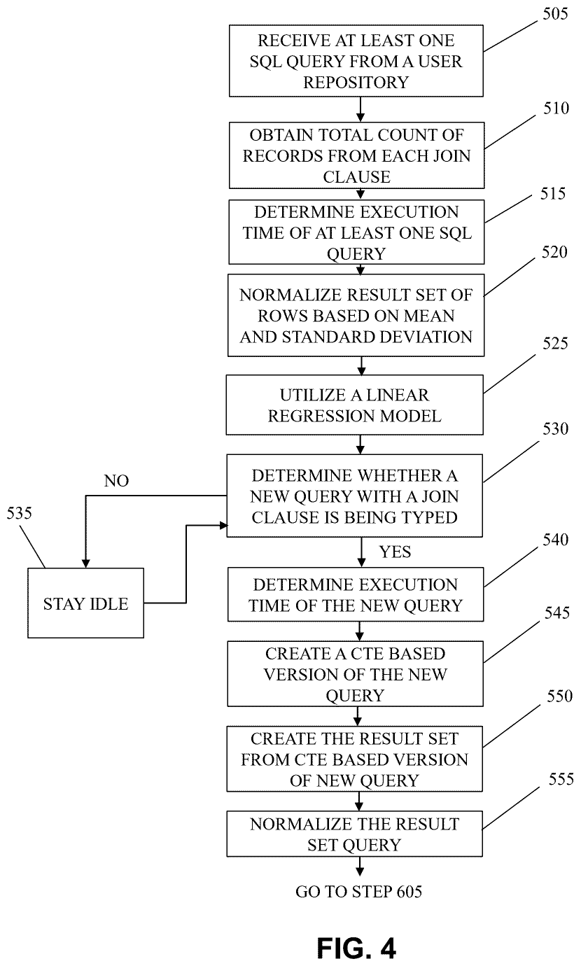

FIG. 4 shows a flowchart of an exemplary method in accordance with aspects of the present invention. Steps of the method may be carried out as operations in the environment 205 of FIG. 2 and are described with reference to elements depicted in FIG. 2.

At step 505, the system receives, at the SQL query module 210, at least one SQL query from a user repository. In embodiments and as described with FIG. 2, the user repository comprises at least one of a git repository and a local storage. At step 510, the system obtains, at the SQL query module 210, a total count of records that result from each JOIN clause in the at least one SQL query. At step 515, the system determines, at the SQL query module 210, an execution time of each of the at least one SQL query.

At step 520, the system normalizes, at the SQL query module 210, a result set of rows based on mean and standard deviation of the result set of the at least one SQL query. At step 525, the system utilizes, at the SQL query module 210, a linear regression model. In embodiments and as described with FIG. 2, the SQL query module 210 utilizes the linear regression model to create a linear regression graph and fits a linear regression line on the linear regression graph by utilizing the normalized result set and the execution time. At step 530, the system determines, at the SQL query module 210, whether a new query with a JOIN clause is being typed. At step 535, the system stays idle until there is a new query with a JOIN clause being typed in response to determining that there is no query with the JOIN clause being typed. At step 540, the system determines, at the SQL query module 210, an execution time of the JOIN clause of the new query in response to determining that there is a new query with a JOIN clause being typed.

At step 545, the system creates, at the new version query module 212, a common table expression (CTE) based version of the new query with the JOIN clause being typed. At step 550, the system creates, at the new version query module 212, a result set from the CTE based version of the new query with the JOIN clause being typed. At step 555, the system normalizes, at the replacement query module 214, the result set based on the mean and standard deviation of the result set.

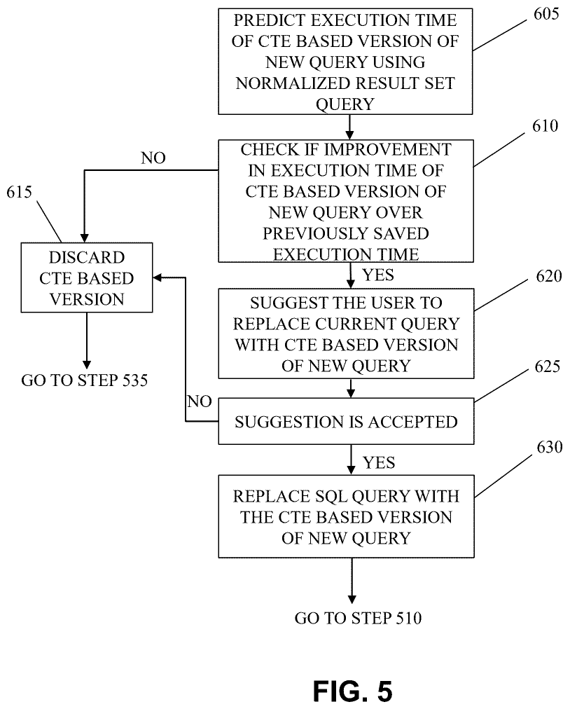

FIG. 5 shows a flowchart of an exemplary method in accordance with aspects of the present invention. Steps of the method may be carried out as operations in the environment 205 of FIG. 2 and are described with reference to elements depicted in FIG. 2. In embodiments, step 605 in FIG. 5 occurs after step 555 in FIG. 4.

At step 605, the system predicts, at the replacement query module 214, an execution time of the CTE based version of the new query from step 545 in FIG. 4 using the normalized result set from step 555 in FIG. 4. At step 610, the system checks, at the replacement query module 214, if there is improvement in execution time of the CTE based version of the new query over a previously saved execution time in memory. In this situation, the replacement query module 214 checks whether the execution time of the CTE based version of the new query has improved over previous queries in the memory. At step 615, the system discards, at the replacement query module 214, the CTE based version of the new query in response to determining that there is no improvement in the execution time of the CTE based version of the normalized result query over the previously saved execution time in memory. At step 620, the system presents, at the replacement query module 214, a suggestion to the user in a user interface of the user computing device of the CTE based version of the new query to replace the current query in response to determining that there is improvement in the execution time of the CTE based version of the new query over the previously saved execution time in the memory.

At step 625, the system determines, at the replacement query 214, whether the suggestion of the CTE based version of the new query is accepted by the user. In step 630, the system replaces, at the replacement query 214, the current query with the CTE based version of the new query in response to the user accepting the suggestion of the CTE based version of the new query. After step 630, the system returns to step 510. In step 615, the system discards, at the replacement query module 214, the CTE based version of the new query in response to the user rejecting the suggestion of the CTE based version of the new query. After step 615, the system returns to step 535.

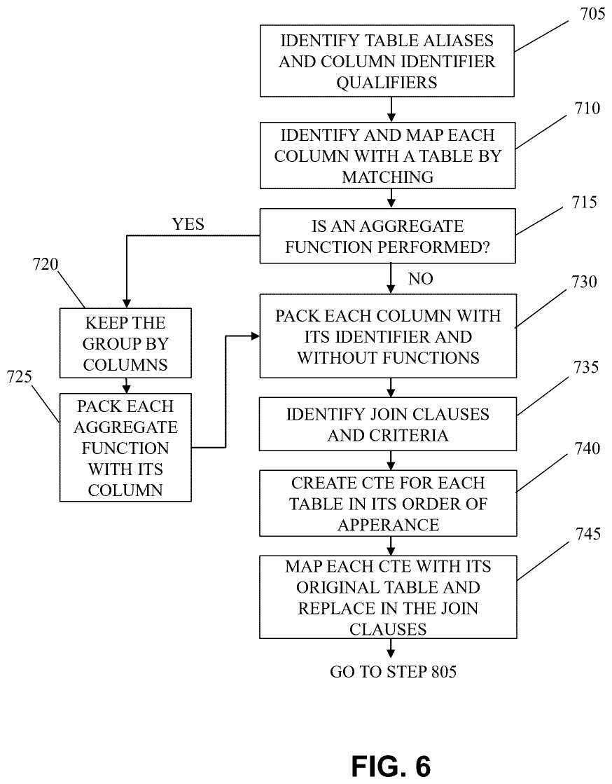

FIG. 6 shows a flowchart of an exemplary method in accordance with aspects of the present invention. Steps of the method may be carried out as operations in the environment 205 of FIG. 2 and are described with reference to elements depicted in FIG. 2.

At step 705, the system identifies, at the new version query module 212, table aliases and column identifier qualifiers from the new query with the JOIN clause being typed at step 530 in FIG. 5. In embodiments, the JOIN clause is a clause which is used to combine rows from two or more tables, based on a related column between the two or more tables. At step 710, the system identifies and maps, at the new version query module 212, each column with the table of the new query with the JOIN clause being typed by matching the column identifier with the table aliases. At step 715, the system checks, at the new version query module 212, whether an aggregation function is performed. At step 720, the system keeps, at the new version query module 212, the GROUP by columns in response to determining that the aggregation function is performed. At step 725, the system packs, at the new version query module 212, each aggregate function with its column after keeping the GROUP by columns.

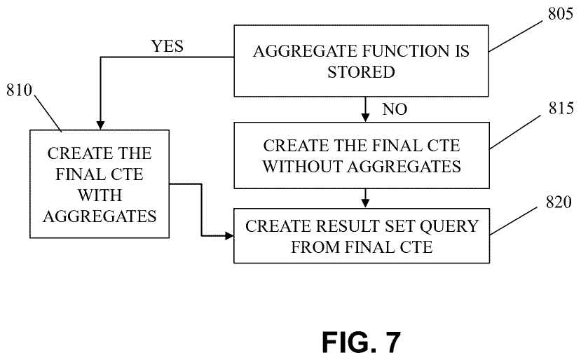

At step 730, the system packs, at the new version query module 212, each column with its identifier and without functions in response to either the aggregate function not being performed or the new version query module 212 packing each aggregate function with is column. At step 735, the system identifies, at the new version query module 212, JOIN clauses and criteria. At step 740, the system creates, at the new version query module 212, a common table expression (CTE) for each table in its order of appearance. At step 745, the system maps, at the new version query module 212, each CTE with its original table replace in the JOIN clauses. After step 735, the system goes to step 805 in FIG. 7.

FIG. 7 shows a flowchart of an exemplary method in accordance with aspects of the present invention. Steps of the method may be carried out as operations in the environment 205 of FIG. 2 and are described with reference to elements depicted in FIG. 2. In embodiments, step 805 in FIG. 7 occurs after step 735 in FIG. 6.

At step 805, the system determines, at the new version query module 212, whether an aggregate function is stored. At step 810, the system creates, at the new version query module 212, a final common table expression (CTE) with aggregates in response to determining that there are stored aggregate functions. At step 815, the system creates, at the new version query module 212, the final CTE without aggregates in response to determining that there are no stored aggregate functions. At step 820, the system creates, at the new version query module 212, a result set query from the final CTE.

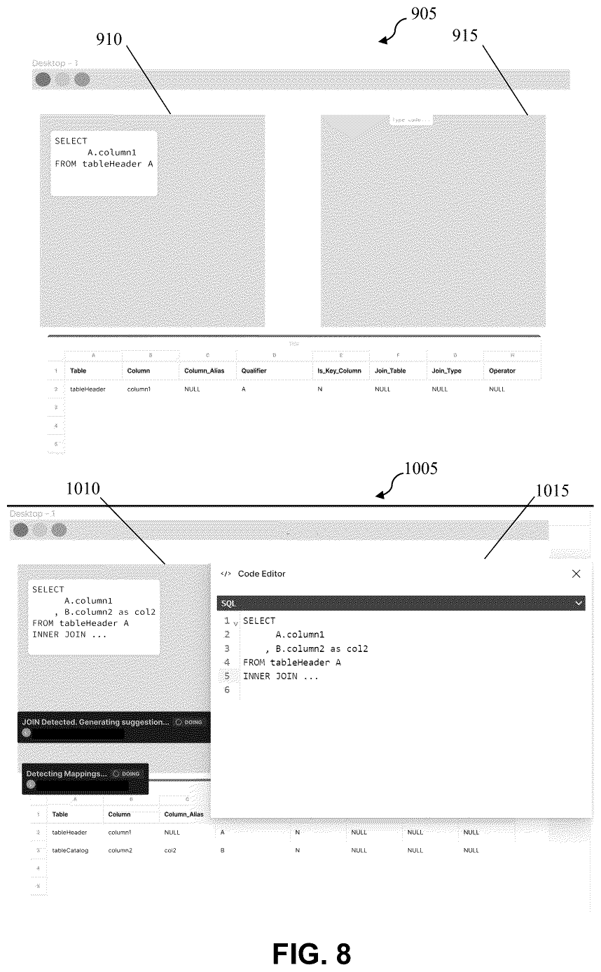

FIG. 8 shows exemplary interfaces of a user input query and a CTE output query in accordance with aspects of the present invention. In further embodiments, FIGS. 8-12 represent successive figures which include an exemplary use case. In the exemplary use case, the user input query changes which also affects a result of the output of the CTE output query.

In embodiments of FIG. 8, an exemplary interface 905 includes a user input query 910 with a SELECT function and a FROM function and a CTE output query 915 (which is blank). In further embodiments, an exemplary interface 1005 includes a user input query 1010 with a SELECT function, a FROM function, and an INNER JOIN function. In further embodiments, the JOIN clause is detected along with corresponding mappings. In aspects of the present invention, the CTE output query 1015 comprises a code editor which includes the SQL code. In further embodiments, the code editor in the CTE output query 1015 can be edited by the user.

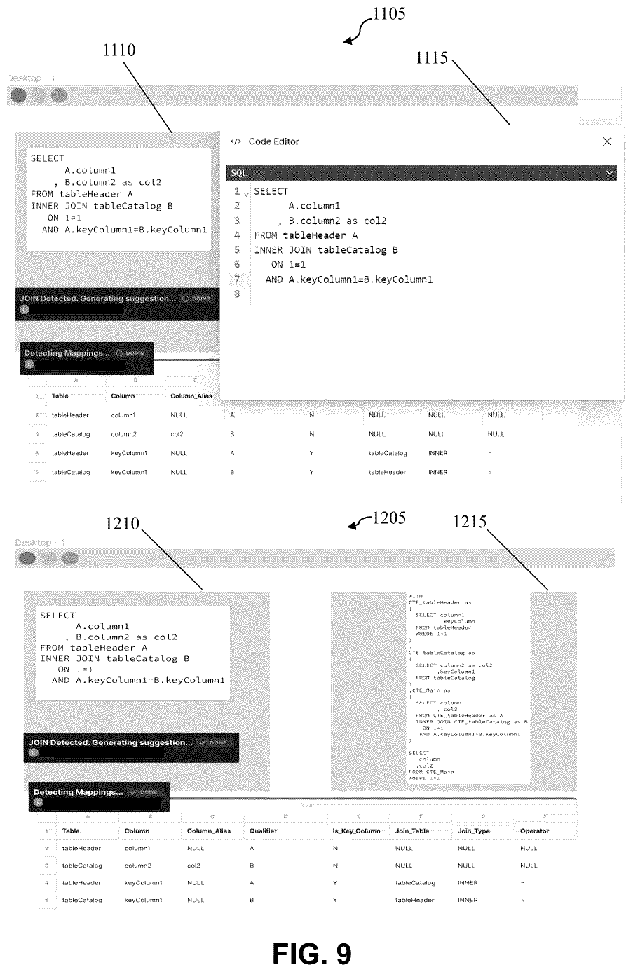

FIG. 9 shows exemplary interfaces of a user input query and a CTE output query in accordance with aspects of the present invention. In embodiments, an exemplary interface 1105 includes a user input query 1110 with a SELECT function, a FROM function, an INNER JOIN function which comprises an ON function and an AND function based on the detected JOIN clause and the corresponding mappings. In further embodiments, the JOIN clause is detected along with corresponding mappings. In aspects of the present invention, the CTE output query 1115 comprises a code editor which includes the SQL code. In embodiments, the SQL code comprises the INNER JOIN of tableCatalog B, the ON function, and the AND function based on the detected JOIN clause and the corresponding mappings. In embodiments, an exemplary interface 1205 includes a user input query 1210 with a SELECT function, a FROM function, an INNER JOIN function which comprises an ON function and an AND function based on the detected JOIN clause and the corresponding mappings. In further embodiments, the JOIN clause is detected along with corresponding mappings. In aspects of the present invention, the CTE output query 1215 comprises a CTE which includes various functions such as SELECT, FROM, WHERE, and INNER JOIN.

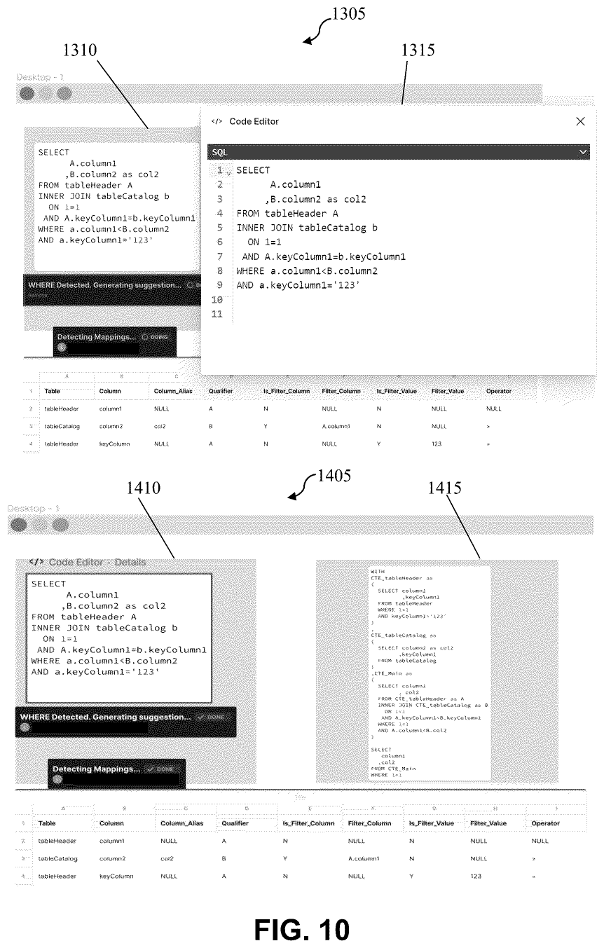

FIG. 10 shows exemplary interfaces of a user input query and a CTE output query in accordance with aspects of the present invention. In embodiments, an exemplary interface 1305 includes a user input query 1310 with a SELECT function, a FROM function, an INNER JOIN function which comprises an ON function and an AND function based on the detected JOIN clause and the corresponding mappings. In further embodiments, the JOIN clause is detected along with corresponding mappings. In aspects of the present invention, the CTE output query 1315 comprises a code editor which includes the SQL code. In embodiments, the SQL code comprises the SELECT function, the FROM function, the INNER JOIN of tableCatalog B, the ON function, the AND, and the WHERE function based on the detected JOIN clause and the corresponding mappings. In embodiments, an exemplary interface 1405 includes a user input query 1410 with a SELECT function, a FROM function, a WHERE function an AND function, and an INNER JOIN function which comprises an ON function and an AND function based on the detected JOIN clause and the corresponding mappings. In further embodiments, the JOIN clause is detected along with corresponding mappings. In aspects of the present invention, the CTE output query 1415 comprises a CTE which includes various functions such as SELECT, FROM, WHERE, and INNER JOIN.

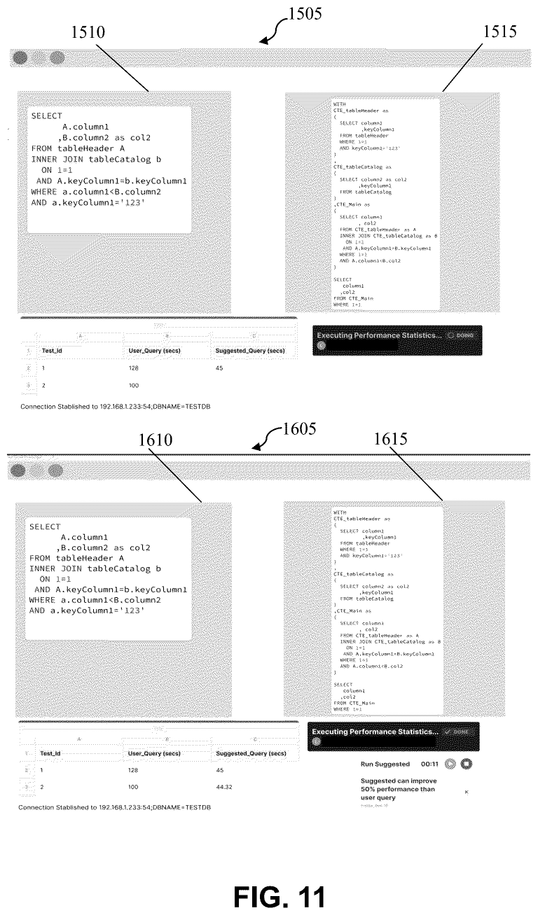

FIG. 11 shows exemplary interfaces of a user input query and a CTE output query in accordance with aspects of the present invention. In embodiments, an exemplary interface 1505 includes a user input query 1510 with a SELECT function, a FROM function, a WHERE function an AND function, and an INNER JOIN function which comprises an ON function and an AND function based on the detected JOIN clause and the corresponding mappings. In further embodiments, the JOIN clause is detected along with corresponding mappings. In aspects of the present invention, the CTE output query 1515 comprises a CTE which includes various functions such as SELECT, FROM, WHERE, and INNER JOIN. In aspects of the present invention, the system of the SQL converter server 208 executes performance statistics to determine an execution time of the current query and the suggested query. In embodiments, an exemplary interface 1605 includes a user input query 1610 with a SELECT function, a FROM function, a WHERE function an AND function, and an INNER JOIN function which comprises an ON function and an AND function based on the detected JOIN clause and the corresponding mappings. In further embodiments, the JOIN clause is detected along with corresponding mappings. In aspects of the present invention, the CTE output query 1615 comprises a CTE which includes various functions such as SELECT, FROM, WHERE, and INNER JOIN. In aspects of the present invention, the system of the SQL converter server 208 executes performance statistics to determine an execution time of the current query and the suggested query and a performance improvement of the suggested query over the current query.

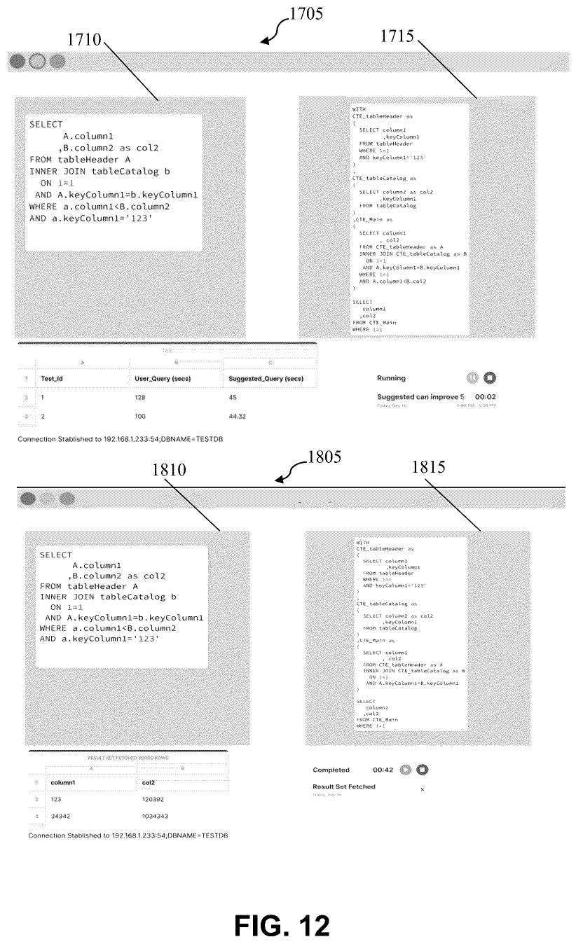

FIG. 12 shows exemplary interfaces of a user input query and a CTE output query in accordance with aspects of the present invention. In embodiments, an exemplary interface 1705 includes a user input query 1710 with a SELECT function, a FROM function, a WHERE function an AND function, and an INNER JOIN function which comprises an ON function and an AND function based on the detected JOIN clause and the corresponding mappings. In further embodiments, the JOIN clause is detected along with corresponding mappings. In aspects of the present invention, the CTE output query 1715 comprises a CTE which includes various functions such as SELECT, FROM, WHERE, and INNER JOIN. In aspects of the present invention, the system of the SQL converter server 208 executes performance statistics to determine an execution time of the current query and the suggested query and a performance improvement of the suggested query over the current query. In embodiments, an exemplary interface 1805 includes a user input query 1810 with a SELECT function, a FROM function, a WHERE function an AND function, and an INNER JOIN function which comprises an ON function and an AND function based on the detected JOIN clause and the corresponding mappings. In further embodiments, the JOIN clause is detected along with corresponding mappings. In aspects of the present invention, the CTE output query 1815 comprises a CTE which includes various functions such as SELECT, FROM, WHERE, and INNER JOIN. In aspects of the present invention, the system of the SQL converter server 208 fetches a result set of the suggested query.

In an exemplary use case, a user utilizes a relational database management system (RDBMS) software program with access to a query repository. In the exemplary use case, the RDBMS software program includes an instance of a database management system to execute queries. For example, the user repository has saved queries as shown below in Table 1:

TABLE 1

| Result Set (in rows) | Time (in seconds) |
|---|---|
| 213309205 | 3 |
| 372342211 | 3.6 |
| 2513680 | 1.2 |

In the exemplary use case, the SQL query module 210 builds a linear regression model with data from the saved queries and views. In particular, the linear regression model uses a summation of a total count of records on each JOIN clause of the saved queries on an X-axis and a run time of the queries on a Y-axis of the linear regression graph. In the exemplary use case, a result set (in rows) is normalized based on a mean and standard deviation defined as shown in Formula 1:

$$Normalized Result Set {X}_{n} = ( X - mean ) / ( standard deviation ) . \qquad ( Formula 1 )$$

In Formula 1, above, the normalized result set Xₙ is based on the result set X, the mean, and the standard deviation of the result set X. In the exemplary use case, the mean is 19605032 and the standard deviation is 185517022. Accordingly, using Formula 1, the normalized result set Xₙ is shown in Table 2:

TABLE 2

| Normalized Result Set Xₙ (in rows) | Time (in seconds) |
|---|---|
| 0.0930059 | 3 |
| 0.950248 | 3.6 |
| −1.043254 | 1.2 |

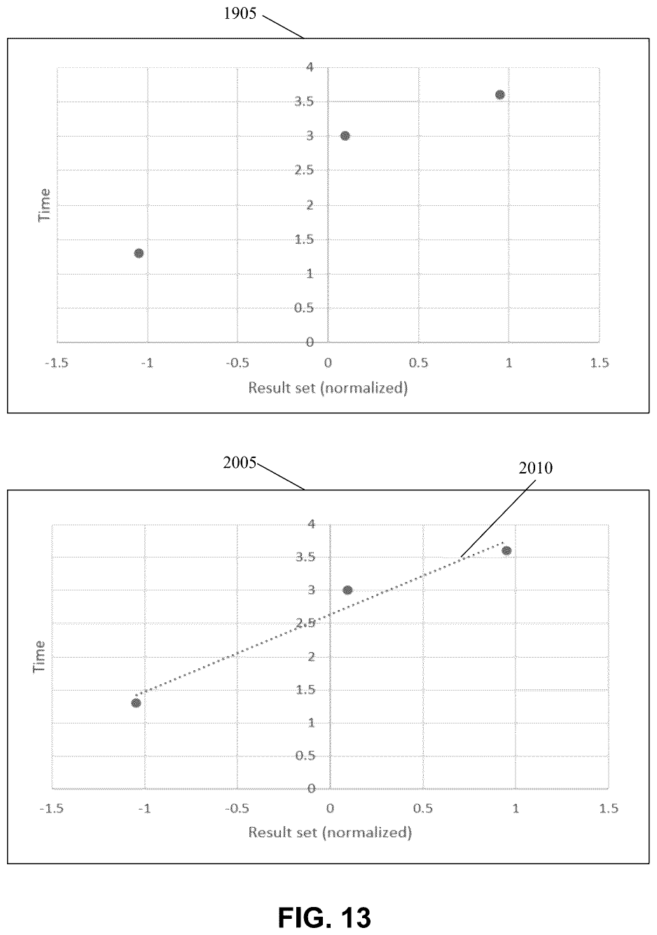

FIG. 13 shows a first graph of an exemplary use case in accordance with aspects of the present invention. In particular, the first graph 1905 comprises a dot plot of the above Table 2. In the first graph, the normalized result set is on the X-axis and the time is on the Y-axis. In further embodiments, a second graph 2005 comprises the dot plot of the first graph 1905 with a trendline 2010 fitted for linear regression. In the exemplary use case, the trendline 2010 corresponds with an equation f (X)=1.17184*X+2.63. In the exemplary use case, the equation f (X) will be used with the machine learning regression model that will be updated based on real-time recommendations.

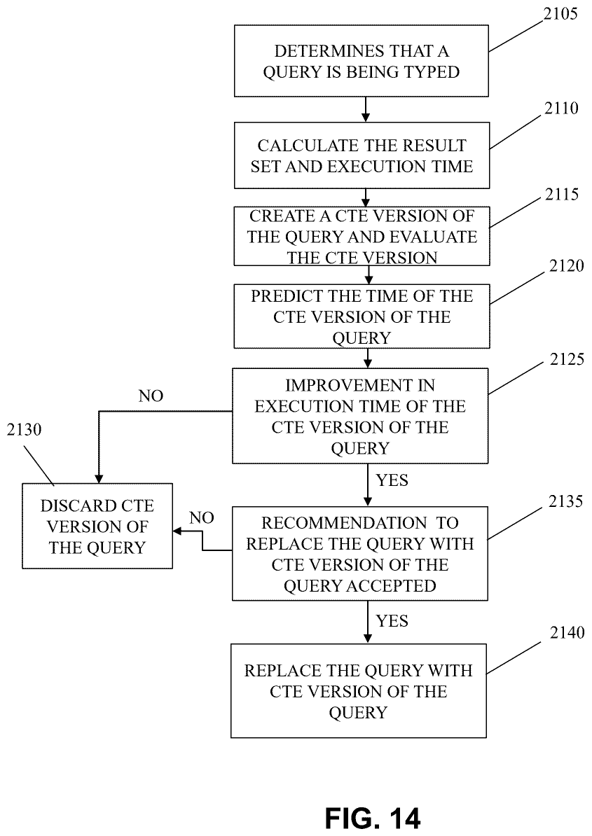

FIG. 14 shows a flowchart of the exemplary use case in accordance with aspects of the present invention. In the exemplary use case, at step 2105, the system determines, at the SQL query module 210, that a query is being typed by a user in a database software. At step 2110, the system calculates, at the SQL query module 210, the result set and the execution time in response to a JOIN clause being typed by the user. In further embodiments, the SQL query module 210 calculates the result set and the execution time in a background. At step 2115, the system creates, at the new version query module 212, a CTE version of the query and evaluates the CTE version of the query. In embodiments, the new version query module 212 creates the CTE version of the query by utilizing a query-to-CTE process. In further embodiments, the new version query module 212 evaluates the CTE version of the query by determining the result set and execution time of the JOIN clause in the CTE version of the query. At step 2120, the system predicts, at the replacement query module 214, the time the CTE version of the query takes to execute the query.

In the exemplary use case, at step 2125, the system determines, at the replacement query module 214, whether there is improvement in execution time of the CTE version of the query in comparison to the execution time of the query. At step 2130, the system discards, at the replacement query module 214, the CTE version of the query in response to determining that there is no improvement in execution time of the CTE version of the query in comparison to the execution time of the query. At step 2135, the system provides, at the replacement query module 214, a recommendation to the user to replace the query with the CTE version of the query and determines whether the user accepts the recommendation. In the exemplary use case, the system discards the CTE version of the query at step 2130 in response to determining that the user does not accept the recommendation. At step 2140, the system replaces, at the replacement query module 214, the query with the CTE version of the query in response to determining that the user accepts the recommendation.

In the exemplary use case, the user introduces a new query as shown below:
SELECT a_something, b_something
FROM Table_1 a JOIN Table_2 b
ON a.key=b.key
WHERE a.year>‘2018’
AND <where_clauses>.

In the exemplary use case of the new query, the system of the SQL converter server 208 gets a result set and execution time for this query, which is 578697513 rows and 4.3 seconds, respectively. In this situation, the system saves the result set and execution time for this query.

In the exemplary use case, the system identifies table name and aliases while maintaining a same order of appearance:
<table_name>=(table_1, a), (table_2, b).

In the exemplary use case, the system of the SQL converter server 208 identifies and maps each column through identifiers:
table_1, a->a.something
table_2, b->b.something.

In the exemplary use case, as there are no functions, the system of the SQL converter server 208 packs the WHERE clause:
<where_clause>=a.year> ‘2018’.

In the exemplary use case, the system of the SQL converter server 208 saves the join criteria:
<join_criteria>=a.key=b.key.

In the exemplary use case, the system of the SQL converter server 208 creates a CTE for each table:

```
WITH table_1_CTE AS (
    SELECT key, something
    FROM table_1
    WHERE 1 = 1
    AND year > ‘2018’
),
table_2_CTE AS (
    SELECT key, something
    FROM table_2
    WHERE 1 = 1
).
```

In the exemplary use case, the JOIN criteria uses the CTE instead of the original table:
<join_criteria_with_cte>=table_1_cte.key=table_2_cte.key.

In the exemplary use case, the system of the SQL converter server 208 creates a final CTE:

CTE_ResultSet AS (
SELECT a.something, b.something
FROM table_1_CTE a JOIN table_2_CTE b
On a.key = b.key
WHERE 1 = 1
)

In the exemplary use case, the system of the SQL converter server 208 creates a result set and appends for a final CTE query:

```
WITH table_1_CTE AS (
    SELECT key, something
    FROM table_1
    WHERE 1 =1
    AND year > ‘2018’
)
Table_2_CTE AS (
    SELECT key, something
    FROM table_2
    WHERE 1 = 1
)
CTE_ResultSet AS (
    SELECT a.something, b.something
    FROM table_1_CTE a JOIN table_2_CTE b
    On a.key = b.key
    WHERE 1 = 1
)
SELECT rs.somthing_a, rs.something_b
FROM CTEResultSet rs
WHERE 1 =1.
```

As shown above, in the exemplary use case, the system of the SQL converter server 208 evaluates the same JOIN clause and finds out that the result set has decreased to 134774275 rows. The system of the SQL converter server 208 normalizes this value and uses the linear regression equation to predict how much time the result set takes. For example, by using Formula 1 above (e.g., Normalized Result Set Xₙ=(X−mean)/(standard deviation), the normalized result set value is −0.330324.

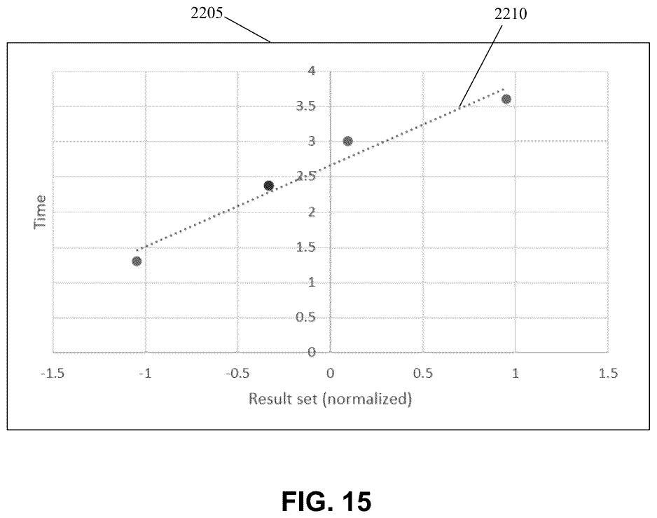

FIG. 15 shows a third graph of the exemplary use case in accordance with aspects of the present invention. In particular, by substituting x=−0.330324 in the equation f(X)=1.17184*X+2.63, the system of the SQL converter server 208 predicts an execution time of approximately 2.25 seconds for the result set. In further embodiments, FIG. 15 comprises the dot plot of the third graph 2205 with a trendline 2210 fitted for linear regression. In the exemplary use case, the trendline 2210 corresponds with the equation f (X)=1.17184*X+2.63. In the exemplary use case, the equation f (X) will be used with the machine learning model regression model that will be updated based on real-time recommendations.

Then, by substituting x=−0.330324 in the equation f (X)=1.17184*X+2.63, the system predicts an execution time of approximately 2.25 seconds for the result set. Accordingly, since there is a potential performance improvement for the result set, the system of the SQL converter server 208 proceeds to recommend the CTE query corresponding to the result set to the user. In further embodiments, the system of the SQL converter server 208 recommends the CTE query corresponding to the result set to the user by stating that there is an improvement of about 2.05 seconds for the recommended CTE query. The system of the SQL converter server 208 replaces the current non-CTE query with the recommended CTE query in response to the user accepting the recommended CTE query. The system also saves the recommended CTE query for future re-fitting.

In the exemplary use case, the system of the SQL converter server 208 re-fits and trains the linear regression model with the saved recommended CTE query. In implementations of the present invention, the machine learning linear regression model shifts model values a bit to reflect the behavior of future queries based on the saved recommended CTE query. In further embodiments of the present invention, the system of the SQL converter server 208 performed the recommended CTE query in real-life, and the recommended query ended up taking 2.37 seconds, which is very similar to the predicted execution time of approximately 2.25 seconds.

In still additional embodiments, the present invention provides a computer-implemented method, via a network. In this case, a computer infrastructure, such as computer 101 of FIG. 1, can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
receiving a structured query language (SQL) query from a user repository;
determining a first execution time of the SQL query;
creating a linear regression graph with a fitted linear regression line by utilizing a linear regression model based on the first execution time and a result set of rows of the SQL query;
determining that there is a new query with a clause;
determining a second execution time of the new query;
creating a common table expression (CTE) based version of the new query based on the second execution time of the new query;
creating a result set of the CTE based version of the new query;
predicting a third execution time of the CTE based version of the new query; and
replacing the SQL query with the CTE based version of the new query in response to the predicted third execution time of the CTE based version of the new query being less than the first execution time of the SQL query.

2. The method of claim 1, further comprising determining a total count of records that result from each clause in the SQL query.

3. The method of claim 1, further comprising normalizing the result of rows of the SQL query based on a mean and a standard deviation of the SQL query.

4. The method of claim 1, wherein the linear regression model comprises a machine learning linear regression model that is trained on historical SQL queries using a linear regression algorithm.

5. The method of claim 4, further comprising re-fitting and training the linear regression model using the CTE based version of the new query.

6. The method of claim 1, further comprising normalizing the result set of the CTE based version of the new query based on a mean and a standard deviation of the result set of the CTE based version of the new query.

7. The method of claim 1, further comprising suggesting the CTE based version of the new query to a user.

8. The method of claim 7, wherein the determining that there is the new query with the clause further comprises determining that there is the new query with a JOIN clause being typed by the user.

9. The method of claim 1, wherein the linear regression graph comprises an X-axis that represents a normalized result set of rows and a Y-axis that represents the first execution time.

10. The method of claim 1, wherein the predicted third execution time of the CTE based version of the new query is based on the linear regression model.

11. The method of claim 1, wherein the user repository comprises a distributed version control system.

12. A computer program product comprising:
one or more computer readable storage media; and
program instructions stored on the one or more computer readable storage media to perform operations comprising:
receiving a structured query language (SQL) query from a user repository;
determining a first execution time of the SQL query;
creating a linear regression graph with a fitted linear regression line by utilizing a linear regression model based on the first execution time and a result set of rows of the SQL query;
determining that there is a new query with a clause;
determining a second execution time of the new query;
creating a common table expression (CTE) based version of the new query based on the second execution time of the new query;
creating a result set of the CTE based version of the new query;
predicting a third execution time of the CTE based version of the new query; and
replacing the SQL query with the CTE based version of the new query in response to the predicted third execution time of the CTE based version of the new query being less than the first execution time of the SQL query.

13. The computer program product of claim 12, wherein the operations further comprise determining a total count of records that result from each clause in the SQL query.

14. The computer program product of claim 12, wherein the operations further comprise normalizing the result of rows of the SQL query based on a mean and a standard deviation of the SQL query.

15. The computer program product of claim 12, wherein the linear regression model comprises a machine learning linear regression model that is trained on historical SQL queries using a linear regression algorithm.

16. The computer program product of claim 15, wherein the operations further comprising re-fitting and training the linear regression model using the CTE based version of the new query.

17. The computer program product of claim 12, wherein the operations further comprise normalizing the result set of the CTE based version of the new query based on a mean and a standard deviation of the result set of the CTE based version of the new query.

18. The computer program product of claim 12, wherein the predicted third execution time of the CTE based version of the new query is based on the linear regression model.

19. The computer program product of claim 12, wherein the determining that there is the new query with the clause further comprises determining that there is the new query with a JOIN clause being typed by a user.

20. A system comprising:
a processor set;
one or more computer readable storage media; and
program instructions stored on the one or more computer readable storage media to cause the processor set to perform operations comprising:
receiving a structured query language (SQL) query from a user repository;
determining a first execution time of the SQL query;
creating a linear regression graph with a fitted linear regression line by utilizing a linear regression model based on the first execution time and a result set of rows of the SQL query;
determining that there is a new query with a clause being typed;
determining a second execution time of the new query;
creating a common table expression (CTE) based version of the new query based on the second execution time of the new query;
creating a result set of the CTE based version of the new query;
predicting a third execution time of the CTE based version of the new query based on the linear regression model;
suggesting a replacement of the SQL query with the CTE based version of the new query; and
replacing the SQL query with the CTE based version of the new query in response to an acceptance of a suggestion that the SQL query be replaced with the CTE based version of the new query.
